(19) United States
(12) Patent Application Publication
(10) Pub. No.: US 2015/0363841 A1
(43) Pub. Date: Dec. 17, 2015

(54) System, Method, and Apparatus for Generating Ratings for Material Transportation

(71) Applicant: Shaleapps, LLC, Bloomfield Heights, MI (US)

(72) Inventors: James Chance Richie, Bloomfield Hills, MI (US); Amanda Christides, Bloomfield Hills, MI (US); Adam M. Klenk, Morgantown, WV (US)

(21) Appl. No.: 14/736,583

(22) Filed: Jun. 11, 2015

Related U.S. Application Data
(60) Provisional application No. 62/010,721, filed on Jun. 11, 2014.

(51) Int. Cl. G06Q 30/02

(52) U.S. Cl. CPC G06Q 30/0282

(57) ABSTRACT

The present invention relates to a method, system, and apparatus for providing material transportation efficiency ratings, including receiving haul data for a plurality of hauls made by a plurality of vehicles. The haul data for each haul of the plurality of hauls comprises a haul volume, a haul distance, a haul cost, and a haul time. The method also includes generating, with at least one processor and based on the haul data, a plurality of efficiency ratings comprising an efficiency rating for at least one of the following: each driver associated with the plurality of vehicles, each transportation entity associated with the plurality of vehicles, each haul of the plurality of hauls, or any combination thereof.

### CROSS REFERENCE TO RELATED APPLICATION

This application claims priority to U.S. Provisional Application Ser. No. 62/010,721 filed on Jun. 11, 2014, the disclosure of which is hereby incorporated in its entirety by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

1. Field of the Invention

This invention relates generally to material transportation and, more specifically, to a system, method, and apparatus for generating ratings and/or rankings for vehicles, drivers, transportation entities, and/or routes involved in the hauling of materials.

2. Description of Related Art

The transportation of materials by vehicles, such as trucks, can be costly and involve many complications. The safe and efficient transportation of materials often requires hiring trucking companies, drivers, and/or renting vehicles. When materials are continually transported, these costs can be large in the aggregate.

### SUMMARY OF THE INVENTION

Generally, provided are an improved system, method, and apparatus for generating ratings and/or rankings for vehicles, drivers, transportation entities, and/or routes involved in the hauling of materials.

According to a preferred and non-limiting embodiment of the present invention, provided is a computer-implemented method for providing material transportation efficiency ratings, comprising: receiving haul data for a plurality of hauls made by a plurality of vehicles, the haul data for each haul of the plurality of hauls comprising a haul volume, a haul distance, a haul cost, and a haul time; and generating, with at least one processor and based on the haul volume, the haul distance, the haul cost, and the haul time, a plurality of efficiency ratings comprising an efficiency rating for at least one of the following: each driver associated with the plurality of vehicles, each transportation entity associated with the plurality of vehicles, each haul of the plurality of hauls, or any combination thereof.

According to another preferred and non-limiting embodiment of the present invention, provided is a material transportation efficiency rating system, comprising: at least one data storage device comprising haul data, the haul data comprising, for each haul of a plurality of hauls, a haul volume, a haul distance, a haul cost, a haul duration, or any combination thereof, wherein each haul is associated with a truck, a driver, and/or a trucking entity; and at least one computer comprising at least one processor programmed or configured to: for each of a plurality of drivers and/or trucking entities, determine at least one efficiency rating based on the haul volume, the haul distance, the haul cost, and the haul time, resulting in a plurality of efficiency ratings; rank the plurality of efficiency ratings based on a scale or range, resulting in ranked efficiency ratings; and generate at least one graphical user interface comprising at least a portion of the ranked efficiency ratings.

According to a further preferred and non-limiting embodiment of the present invention, provided is a computer program product for generating material transportation efficiency ratings, comprising at least one non-transitory computer-readable medium comprising program instructions that, when executed by at least one processor, cause the at least one processor to: obtain haul data for at least one haul made by at least one of a driver and a transportation entity, the haul data comprising a haul volume, a haul distance, a haul cost, and a haul time; and generate, with at least one processor and based at least partially on the haul data, a plurality of efficiency ratings comprising an efficiency rating for at least one of the following: each driver associated with the plurality of vehicles, each transportation entity associated with the plurality of vehicles, each haul of the plurality of hauls, or any combination thereof, wherein each efficiency rating is generated such that it is directly proportional to the haul volume and haul distance, and indirectly proportional to the haul cost and the haul time.

These and other features and characteristics of the present invention, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and the claims, the singular form of “a”, “an”, and “the” include plural referents unless the context clearly dictates otherwise.

### BRIEF DESCRIPTION OF THE DRAWINGS

FIG. 1 depicts a schematic diagram of a system for generating ratings for material transportation according to the principles of the present invention;

FIG. 2A depicts a graphical user interface for displaying ratings for material transportation according to the principles of the present invention;

FIG. 2B depicts another graphical user interface for displaying ratings for material transportation according to the principles of the present invention;

FIG. 3 depicts a flow diagram for a method for generating ratings for material transportation according to the principles of the present invention; and

FIG. 4 depicts a diagram of a computer environment according to the prior art.

### DESCRIPTION OF THE INVENTION

For purposes of the description hereinafter, the terms “upper”, “lower”, “right”, “left”, “vertical”, “horizontal”, “top”, “bottom”, “lateral”, “longitudinal” and derivatives thereof shall relate to the invention as it is oriented in the drawing figures. However, it is to be understood that the invention may assume various alternative variations and step sequences, except where expressly specified to the contrary. It is also to be understood that the specific devices and processes illustrated in the attached drawings, and described in the following specification, are simply exemplary embodiments of the invention. Hence, specific dimensions and other physical characteristics related to the embodiments disclosed herein are not to be considered as limiting.

As used herein, the terms “communication” and “communicate” refer to the receipt or transfer of one or more signals, messages, commands, or other type of data. For one unit or device to be in communication with another unit or device means that the one unit or device is able to receive data from and/or transmit data to the other unit or device. A communication may use a direct or indirect connection, and may be wired and/or wireless in nature. Additionally, two units or devices may be in communication with each other even though the data transmitted may be modified, processed, routed, etc., between the first and second unit or device. For example, a first unit may be in communication with a second unit even though the first unit passively receives data, and does not actively transmit data to the second unit. As another example, a first unit may be in communication with a second unit if an intermediary unit processes data from the first unit and transmits processed data to the second unit. It will be appreciated that numerous other arrangements are possible.

As used herein, the term “haul data” refers to one or more parameters, measurements, and/or values for one or more aspects of material transportation. For example, haul data may include a haul duration or time, a haul cost, a haul volume, a haul distance, a haul route, a vehicle identifier, a driver identifier, a transportation entity identifier, and/or the like. Haul data may also include aggregated or processed data, including aggregated values per vehicle, driver, route, transportation entity, and/or the like, from one or more hauls. A haul duration or time may include, for example, a temporal value (e.g., hours, minutes, and/or seconds) representing the time it takes a vehicle to haul material from one location to another, or a value representing partial or multiple hauls of material.

A haul cost may include one or more monetary costs, non-monetary costs, efficiency costs, and/or other factors that may affect the efficiency of one or more hauls. Costs may include, for example, fuel costs, labor costs, equipment rental costs, equipment operation costs, and/or the like. Non-monetary costs may be assigned monetary values for the purpose of calculating a total cost or, in other examples, may be an entirely separate weighted parameter that influences the generation of an efficiency rating. A haul volume may include, for example, a fluid volume, an inventory, a quantity, a material weight, and/or the like. A vehicle identifier, driver identifier, and transportation identifier may uniquely identify, respectively, a vehicle (e.g., by VIN, license plate, unique alphanumeric string, etc., a driver (e.g., by name, identification number, etc.) and a transportation entity (e.g., by trucking company, contractor, etc.).

The haul data may be in the form of one or more data structures, such as, but not limited to, databases, tables, spreadsheets, arrays, and/or the like. The haul data may be stored on one or more data storage devices, such as, but not limited to, hard drives, memory, storage-area network drives, distributed network storage, and/or the like. The haul data may be aggregated from one or more data sources. Such data sources may include mobile devices, server computers, third-party databases, and/or the like. It will be appreciated by those skilled in the art that the haul data may be collected, generated, and/or received in numerous ways. For example, haul data may be received from one or more mobile devices, computers, input devices, etc., and then stored at one or more network-accessible location(s).

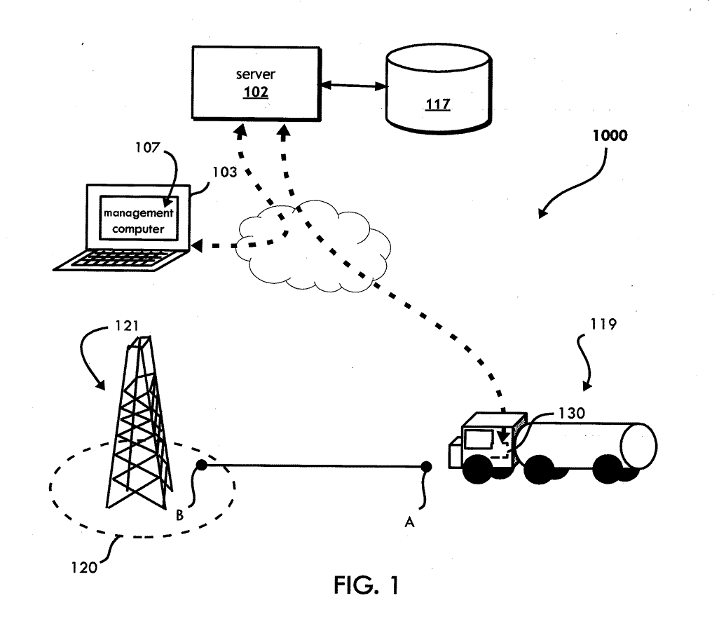

Referring to FIG. 1, a system 1000 for providing material transportation efficiency ratings is shown according to a preferred and non-limiting embodiment. In this example, at least a portion of the haul data is communicated from mobile devices 130 associated with vehicles 119 and/or drivers. For example, location devices (e.g., GPS units or the like) associated with mobile devices 130 carried by drivers or positioned within the vehicles 119 may enable a software application on the mobile devices 130 to transmit haul data, such as location data, route data, and/or the like, to a central server 102. The movement to and from locations A and B at a start time and an end time allow for a trip duration to be determined. For example, a haul duration may be determined based on a number of miles traveled and an average speed, manually inputted values, or a timer that is started and stopped at appropriate times. The mobile devices 130 may also communicate identifiers for the driver, device 130, and/or vehicle 119, and/or other like haul data is stored on, input into, or obtained by the mobile devices 130.

With continued reference to FIG. 1, a system 1000 for providing material transportation efficiency ratings includes a haul data storage unit 117, which may include one or more databases or other data structures embodied on a storage medium. The haul data provided by the mobile device 130 is transmitted to the server 102 and stored on the haul data storage unit 117. The haul data may be stored local to or remote from the server 102. A well 121 at location B may be within a specified geographic boundary 120 (e.g., geo-fence) that is defined by a set of coordinates and/or a radius from a single point, and allows for the presence and/or absence of the vehicle 119 at location B to be determined. A management computer 103, such as a desktop, laptop, or mobile device, is also in communication with the server 102. The management computer 103 displays one or more graphical user interfaces 107 to track and/or manage the haul data, and to view the efficiency ratings and/or rankings. Systems and methods for generating, collecting, and processing haul data are described in more detail by U.S. patent application Ser. Nos. 14/095,043 and 14/094,981, which are hereby incorporated by reference in their entirety.

In a preferred and non-limiting embodiment, an efficiency rating is calculated by processing, based at least partially on at least one algorithm or data processing step, a portion of the haul data, such as the haul volume, the haul distance, the haul cost, and/or the haul time for one or more hauls of a material. The haul data may be based on a specific vehicle, driver, transportation entity, and/or the like. The haul data may also be calculated from within a specified time range, such as historical haul data, haul data from a previous week, haul data from the past 24 hours, haul data from a driver shift, haul data from a single haul or return trip, or the like. The haul data may also be from a specified number of past hauls, or may be inclusive of all haul data currently available. It will be appreciated that numerous variations are possible.

In a preferred and non-limiting embodiment, an algorithm for determining an efficiency rating includes calculating or determining a value based at least partially on haul volume, haul distance, haul costs, and haul duration. In another preferred and non-limiting embodiment, an algorithm for determining an efficiency rating includes calculating or determining a value based at least partially on a ratio of a first factor to a second factor. The first factor may be representative of positive attributes of one or more hauls, in which a higher value is desirable. For example, the first factor may include a haul volume, a haul distance, and/or other attributes that indicate a benefit conferred by the vehicle, driver, and/or transportation entity. The second factor may include negative attributes that are associated with increased costs and/or a lack of efficiency. For example, the second factor may be based on haul costs and/or haul duration. In this manner, the efficiency rating may be generated such that it is proportional to the first factor and inversely proportional to the second factor. It will be appreciated that numerous other parameters may also be factored into the ratio so that positive attributes are weighed against negative attributes.

In a preferred and non-limiting embodiment, the algorithm includes calculating the product of haul volume and haul distance, and dividing that result by the product of haul costs and haul duration. For example, a rating rₙ can be calculated as follows: rₙ=(dₙ*vₙ)/(cₙ*tₙ), where d is the haul distance, v is the haul volume, c is the haul cost, and t is the haul duration, and where n is a particular vehicle, driver, transportation entity, haul, time period, or the like. It will be appreciated that numerous algorithms or processing steps may be used to weigh the haul data and determine an efficiency rating for a vehicle, driver, transportation entity, or the like. It will be appreciated that other parameters may also be factored into the algorithm, and that additional or different algorithms may be used to process the results.

In a preferred and non-limiting embodiment, other parameters may include a time period during which a truck is filled in one or more shifts, a time period during which a truck is empty in one or more shifts, a time period during which a truck is idle on-site in one or more shifts, a time period during which a truck is idle off-site in one or more shifts, and/or other like efficiency parameters. In these examples, a time period during which a truck is filled may positively affect an efficiency rating, while a time period during which a truck is empty may negatively affect an efficiency rating. A ratio of time periods may also be used to influence the efficiency rating. Other parameters may include, for example, compliance with prescribed routes, compliance with safety measures and practices, and/or other like parameters that may be associated with future costs or liabilities. Each parameter may also be considered as a ratio of that parameter to a cost or a corresponding parameter.

In a preferred and non-limiting embodiment, certain calculations may be made in real-time during a route or haul, or after a route or haul has been completed. After the route has been completed, an average route time can be calculated. Also, after the route has been completed, the route taken by the driver can be compared to predefined routes to determine if the driver deviated from one or more prescribed routes. Compliance with and/or deviation from a desired route can also affect the efficiency ratings such that compliance is a positive factor, and deviation is a negative factor. During the route, the current GPS coordinates of a truck may also be compared to one or more predefined routes in real-time such that alerts can be generated to inform the driver that he or she has deviated from a desirable route. The alerts may be displayed on a mobile device and/or audibly presented to the driver.

In a preferred and non-limiting embodiment, the efficiency ratings are initially generated individually by vehicle, driver, entity, and/or the like, and are raw values output from one or more algorithms and/or calculations. In such embodiments, the raw values may be converted into efficiency ratings and/or rankings that are comparative. This may be accomplished by normalizing the raw values based on a specified range. In such non-limiting examples, the raw values may be sorted and then distributed evenly throughout a specified range (e.g., from 1 to 10, from 0.01 to 1.00, or from 1 to 100). As another non-limiting example, an efficiency rating or raw value may be multiplied by a common factor (e.g., 100/70 or 1.4286). Alternatively, each raw value may be compared to a scale having predefined ranges to determine which range encompasses the raw value. A single value or indicator for the range may then be used in place of the raw value. The raw values may also be ranked in a sequential order through use of a sorting algorithm, and the rankings used in addition to or in place of the efficiency ratings. The rankings may be based on vehicle, driver, entity, and/or the like. It will be appreciated that the calculated efficiency ratings may be formatted, modified, and/or normalized in any number of ways.

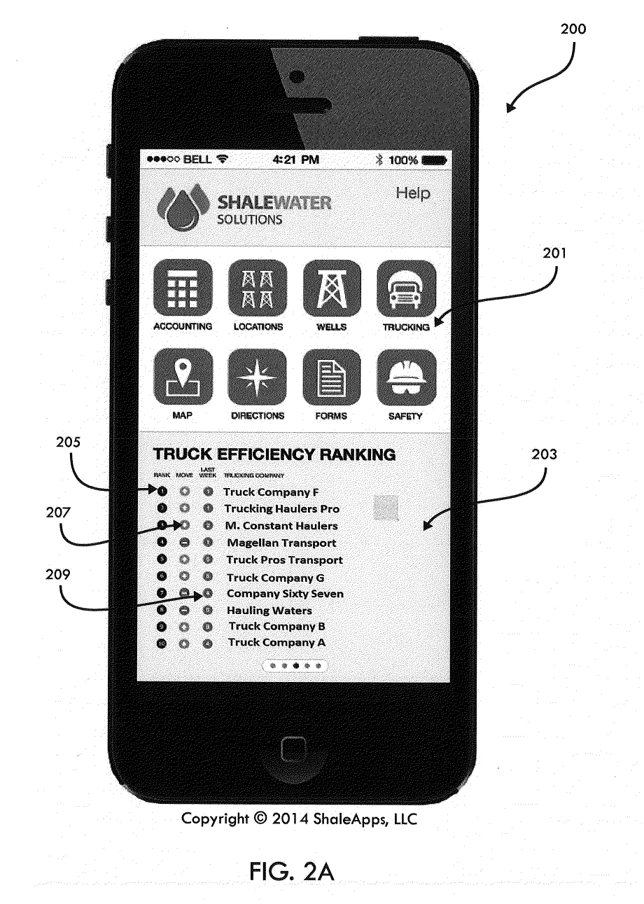

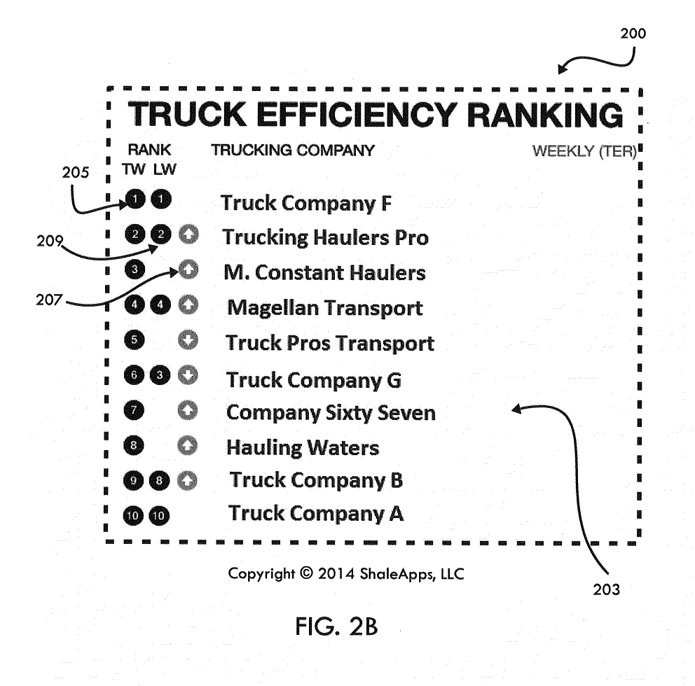

Referring now to FIG. 2A, a graphical user interface 200 is shown according to a preferred and non-limiting embodiment. The interface includes a menu 201 having a plurality of icons for navigating the software application. An efficiency rating section 203 of the interface 200 includes a list of transportation entities. In this non-limiting example, the material transportation entities (such as, for example, trucking companies) are ranked by efficiency ratings. A sequential rank 205 is shown from 1 to 10. A movement indicator 207 visually indicates whether the rank for a particular transportation entity has increased, decreased, or remained static over time or in comparison to the last calculation, period of time, or the like. As illustrated, the movement indicator 207 may be an icon showing an up arrow to indicate an increase in rating/ranking, a down arrow to indicate a decrease in rating/ranking, or a hyphen to indicate no change in rating/ranking. The movement indicator 207 may also be color-coded. It will be appreciated that the movement indicator 207 may be in various forms, including text and other types of icons. Further, a previous ranking 209 is shown for each entity. In the illustrated example, the previous ranking 209 displays the ranking from the previous week. However, it will be appreciated that the previous ranking may be from a previous haul, day, month, year, or the like.

Further, in some non-limiting embodiments, the user interface 200 may provide selectable options, such as, but not limited to, buttons, drop-down menus, radio buttons, checkboxes, hyperlinks, and/or the like. These selectable options may allow a user to selectively view the efficiency ratings by vehicle, driver, entity, route, and/or the like. The selectable options may also allow a user to rank the vehicles, drivers, entities, routes, and/or the like in various ways and based on various factors. The selectable options may also be used to view the efficiency ratings and/or rankings over a specified period of time or to facilitate the creation of a custom algorithm or formula for generating or influencing the efficiency ratings. Graphs, charts, and other visual representations may be automatically generated to show efficiency ratings or rankings over time.

Referring now to FIG. 2B, an efficiency rating section 203 of a graphical user interface 200 is shown according to another preferred and non-limiting embodiment. In this example, a sequential rank 205 of efficiency ratings from a present week is shown adjacent a sequential rank 209 of efficiency ratings from a previous week. Further, movement indicators 207 in this embodiment are shown for upwards or downwards movement, but not for a trucking company that does not change in ranking.

In a non-limiting embodiment, at least a portion of the haul data may be modified or limited in relevancy and influence to the calculations of the efficiency ratings. For example, the influence of the haul duration or other portion of the haul data on a rating may be limited to discourage unsafe driving practices, such as exceeding speed limits to establish better efficiency ratings. The haul duration may have a minimum and/or maximum for a given distance or route, or a speed limit for one or more roads on a route used for a haul may be used to calculate a shortest possible duration for that route. In such examples, a haul duration less than this value will not positively benefit the rating. The haul duration may also be modified if the driver experiences a delay or setback on a route or at a location. A time of day, day of the week, or traffic pattern may also affect the haul duration. For example, the duration may be shortened if the haul is made during a high-traffic time of day or in a high-traffic area. It will be appreciated that various other factors may be modified based on other data. For example, a miles-per-gallon rate, fuel cost, labor cost, vehicle cost, and/or vehicle wear could be factored into the haul cost for one or more hauls.

In some non-limiting examples, unsafe driving practices evidenced from speeding, lack of compliance to regulations, or the like, may be factored into the efficiency rating to effectively lower the rating and discourage such practices. For example, a vehicle speed over a defined threshold (generally, per route, or per segment of route) may be a negative factor and may also be used to generate an alert. Threshold speed limits may be provided in a maintained database and/or one or more third-party data sources (e.g., Google Maps, Bing Maps, government sources, and/or the like). Vehicle speed may be determined from a truck computer that is in communication with a network either directly or indirectly through a mobile device that is in communication with a network. Vehicle speed may also be calculated by using GPS data from a mobile device by determining a change in GPS coordinates over a period of time. As an example, GPS waypoints may be determined at intervals (e.g., every 5 seconds) and transmitted to the server individually or in batches. Such-calculations may be performed locally on the mobile device or by a server that obtains such data. Moreover, hard braking (e.g., when a driver uses more force than normal to brake the vehicle) may be detected and used as a negative factor in generating an efficiency rating. Hard braking may also be determined in any number of ways including, but not limited to, communication with a truck computer or a detected change in GPS coordinates over a period of time (e.g., determining a vehicle speed and then a stopping speed).

In a non-limiting embodiment, the efficiency ratings may be used to compare drivers, vehicles, transportation entities, and/or routes in various ways. Comparison reports may be generated to compare ratings over a time period (e.g., a shift, a single haul, a day, a week, a year, etc.) for a particular driver, vehicle, or transportation entity. In this way, the performance for a driver, vehicle, or entity can be assessed over time (e.g., an increase or decrease in performance). For example, a report may be generated to compare efficiency ratings for drivers with respect to a particular route of travel over a previous week or month. A report may also be generated for drivers over a previous week or month without regard to what specific routes were driven. As another example, a report may be generated to compare efficiency ratings for trucking companies over a previous week or month without regard for what routes were traveled. In a further example, efficiency ratings may be calculated for specific routes such that haul data from multiple drivers and/or multiple transportation entities may be aggregated to determine which routes are the most efficient to travel.

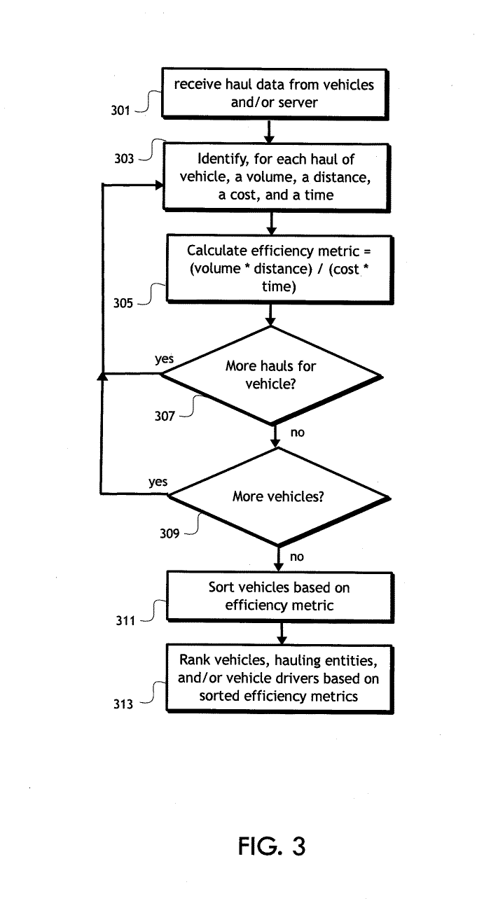

Referring now to FIG. 3, a flow diagram for a method for generating ratings for material transportation is shown according to a preferred and non-limiting embodiment. At step 301, haul data is received from vehicles and/or a server. At step 303, a volume, distance, cost, and duration are identified for each haul of a vehicle. At step 305, an efficiency metric is calculated with an algorithm. In this example, the algorithm calculates a product of a haul volume and haul distance, and divides the result by the product of a haul cost and a haul time. Various other algorithms and formulas may be used. At step 307, it is determined if there are more hauls for that vehicle in a given shift, period of time, or the like. If there are more hauls to factor into the efficiency metric, the method proceeds back to step 303 and the volume, distance, cost, and duration is identified for the next haul. Otherwise, the method proceeds to step 309 at which it is determined if there are more vehicles. If there are more vehicles, drivers, and/or transportation entities that have not yet had efficiency metrics calculated, the method proceeds back to step 303. If there are no more vehicles to calculate metrics for, the vehicles are sorted based on the efficiency metrics at step 311. At step 313, the vehicles are ranked based on the sorted efficiency metrics. As described herein, it will be appreciated that the efficiency metrics may also be calculated for drivers, transportation entities, and/or routes, and may be calculated for a particular haul, a particular shift, a specified period of time, or the like.

In a preferred and non-limiting embodiment, the haul cost may be calculated in various ways. As mentioned above, a haul cost may include one or more monetary costs, non-monetary costs, efficiency costs, or other factors that affect the efficiency of one or more hauls. Additionally, a haul cost may differentiate between a cost for driving time and a cost for idling time. For example, a cost for driving time may include costs such as fuel, labor, vehicle wear, vehicle costs, and/or the like. A cost for idling time may also include costs such as fuel, labor, and/or vehicle costs that are incurred while the vehicle is idling (e.g., at a fuel station, at a red light, in traffic, etc.). In some examples, the cost for idling time may be further differentiated between expected idling time and unexpected idling time. For example, an expected idling time may include red lights and fuel stops that are planned or routinely incurred. An unexpected idling time may include unexpected traffic, an accident, vehicle problems, and/or the like. It will be appreciated that these factors may be used to influence the efficiency ratings in various ways, and may also be used for analytics and accounting purposes.

In a preferred and non-limiting embodiment, the generated efficiency ratings may be generated per route to provide consistency across different vehicles, drivers, and/or trucking companies. For example, certain routes may be plagued by traffic delays, road conditions, and/or other factors that could potentially have a negative impact on an efficiency rating. If a driver or transportation entity travels such routes more regularly than other drivers or transportation entities, the driver or transportation entity may be unfairly prejudiced. Accordingly, each driver and/or transportation entity may be assigned an efficiency rating per route such that drivers and/or transportation entities are compared for efficiency with respect to a given route, rather than all routes in the aggregate. Alternatively, specific routes and/or segments of routes may be associated with weights that are used in the generation of the efficiency ratings. For example, a route that commonly experiences setbacks may be associated with a weighted parameter that positively affects the efficiency rating to balance the efficiency ratings. Similarly, a route that generally experiences fewer than average setbacks may be associated with a weighted parameter that negatively affects the efficiency ratings.

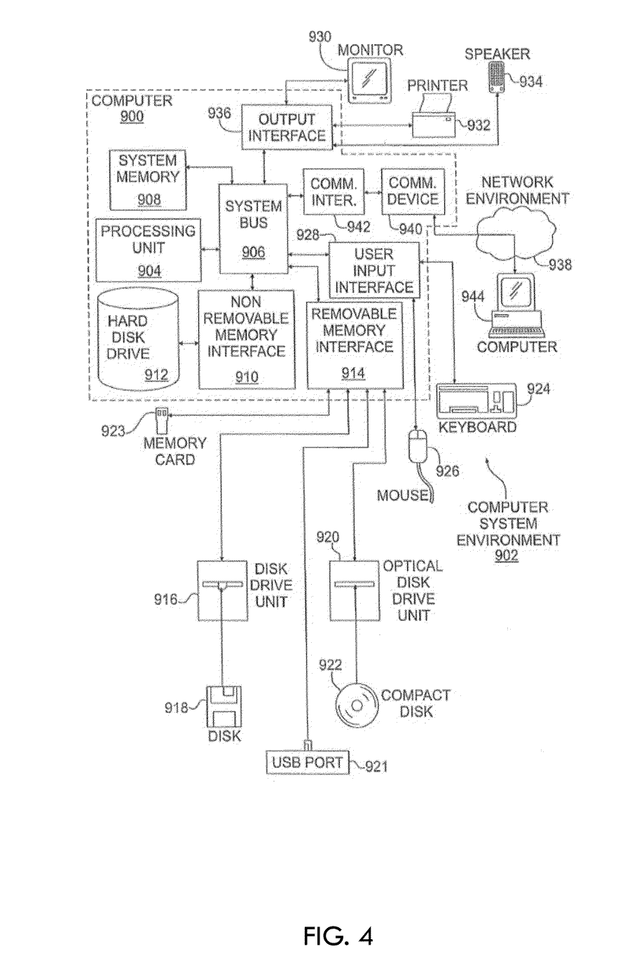

The present invention may be implemented on a variety of computing devices and systems, including the mobile devices and/or server computer, wherein these computing devices include the appropriate processing mechanisms and computer-readable media for storing and executing computer-readable instructions, such as programming instructions, code, and the like. As shown in FIG. 4, personal computers 900, 944, in a computing system environment 902 are provided. This computing system environment 902 may include, but is not limited to, at least one computer 900 having certain components for appropriate operation, execution of code, and creation and communication of data. For example, the computer 900 includes a processing unit 904 (typically referred to as a central processing unit or CPU) that serves to execute computer-based instructions received in the appropriate data form and format. Further, this processing unit 904 may be in the form of multiple processors executing code in series, in parallel, or in any other manner for appropriate implementation of the computer-based instructions.

In order to facilitate appropriate data communication and processing information between the various components of the computer 900, a system bus 906 is utilized. The system bus 906 may be any of several types of bus structures, including a memory bus or memory controller, a peripheral bus, or a local bus using any of a variety of bus architectures. In particular, the system bus 906 facilitates data and information communication between the various components (whether internal or external to the computer 900) through a variety of interfaces, as discussed hereinafter.

The computer 900 may include a variety of discrete computer-readable media components. For example, this computer-readable media may include any media that can be accessed by the computer 900, such as volatile media, non-volatile media, removable media, non-removable media, etc. As a further example, this computer-readable media may include computer storage media, such as media implemented in any method or technology for storage of information, such as computer-readable instructions, data structures, program modules, or other data, random access memory (RAM), read only memory (ROM), electrically erasable programmable read only memory (EEPROM), flash memory, or other memory technology, CD-ROM, digital versatile disks (DVDs), or other optical disk storage, magnetic cassettes, magnetic tape, magnetic disk storage, or other magnetic storage devices, or any other medium which can be used to store the desired information and which can be accessed by the computer 900. Further, this computer-readable media may include communications media, such as computer-readable instructions, data structures, program modules, or other data in other transport mechanisms and include any information delivery media, wired media (such as a wired network and a direct-wired connection), and wireless media. Computer-readable media may include all machine-readable media with the sole exception of transitory, propagating signals. Of course, combinations of any of the above should also be included within the scope of computer-readable media.

The computer 900 further includes a system memory 908 with computer storage media in the form of volatile and non-volatile memory, such as ROM and RAM. A basic input/output system (BIOS) with appropriate computer-based routines assists in transferring information between components within the computer 900 and is normally stored in ROM. The RAM portion of the system memory 908 typically contains data and program modules that are immediately accessible to or presently being operated on by processing unit 904, e.g., an operating system, application programming interfaces, application programs, program modules, program data and other instruction-based computer-readable codes.

With continued reference to FIG. 4, the computer 900 may also include other removable or non-removable, volatile or non-volatile computer storage media products. For example, the computer 900 may include a non-removable memory interface 910 that communicates with and controls a hard disk drive 912, i.e., a non-removable, non-volatile magnetic medium; and a removable, non-volatile memory interface 914 that communicates with and controls a magnetic disk drive unit 916 (which reads from and writes to a removable, non-volatile magnetic disk 918), an optical disk drive unit 920 (which reads from and writes to a removable, non-volatile optical disk 922, such as a CD ROM), a Universal Serial Bus (USB) port 921 for use in connection with a removable memory card, etc. However, it is envisioned that other removable or non-removable, volatile or non-volatile computer storage media can be used in the exemplary computing system environment 900, including, but not limited to, magnetic tape cassettes, DVDs, digital video tape, solid state RAM, solid state ROM, etc. These various removable or non-removable, volatile or non-volatile magnetic media are in communication with the processing unit 904 and other components of the computer 900 via the system bus 906. The drives and their associated computer storage media discussed above and illustrated in FIG. 4 provide storage of operating systems, computer-readable instructions, application programs, data structures, program modules, program data, and other instruction-based computer-readable code for the computer 900 (whether duplicative or not of this information and data in the system memory 908).

A user may enter commands, information, and data into the computer 900 through certain attachable or operable input devices, such as a keyboard 924, a mouse 926, etc., via a user input interface 928. Of course, a variety of such input devices may be utilized, e.g., a microphone, a trackball, a joystick, a touchpad, a touch-screen, a scanner, etc., including any arrangement that facilitates the input of data, and information to the computer 900 from an outside source. As discussed, these and other input devices are often connected to the processing unit 904 through the user input interface 928 coupled to the system bus 906, but may be connected by other interface and bus structures, such as a parallel port, game port, or a universal serial bus (USB). Still further, data and information can be presented or provided to a user in an intelligible form or format through certain output devices, such as a monitor 930 (to visually display this information and data in electronic form), a printer 932 (to physically display this information and data in print form), a speaker 934 (to audibly present this information and data in audible form), etc. All of these devices are in communication with the computer 900 through an output interface 936 coupled to the system bus 906. It is envisioned that any such peripheral output devices be used to provide information and data to the user.

The computer 900 may operate in a network environment 938′ through the use of a communications device 940, which is integral to the computer or remote therefrom. This communications device 940 is operable by and in communication to the other components of the computer 900 through a communications interface 942. Using such an arrangement, the computer 900 may connect with or otherwise communicate with one or more remote computers, such as a remote computer 944, which may be a personal computer, a server, a router, a network personal computer, a peer device, or other common network nodes, and typically includes many or all of the components described above in connection with the computer 900. Using appropriate communication devices 940, e.g., a modem, a network interface or adapter, etc., the computer 900 may operate within and communication through a local area network (LAN) and a wide area network (WAN), but may also include other networks such as a virtual private network (VPN), an office network, an enterprise network, an intranet, the Internet, etc. It will be appreciated that the network connections shown are exemplary and other means of establishing a communications link between the computers 900, 944 may be used.

As used herein, the computer 900 includes or is operable to execute appropriate custom-designed or conventional software to perform and implement the processing steps of the method and system of the present invention, thereby, forming a specialized and particular computing system. Accordingly, the presently-invented method and system may include one or more computers 900 or similar computing devices having a computer-readable storage medium capable of storing computer-readable program code or instructions that cause the processing unit 902 to execute, configure, or otherwise implement the methods, processes, and transformational data manipulations discussed hereinafter in connection with the present invention. Still further, the computer 900 may be in the form of a personal computer, a personal digital assistant, a portable computer, a laptop, a palmtop, a mobile device, a mobile telephone, a server, or any other type of computing device having the necessary processing hardware to appropriately process data to effectively implement the presently-invented computer-implemented method and system.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

The invention claimed is:

1. A computer-implemented method for providing material transportation efficiency ratings, comprising:
receiving haul data for a plurality of hauls made by a plurality of vehicles, the haul data for each haul of the plurality of hauls comprising a haul volume, a haul distance, a haul cost, and a haul time; and
generating, with at least one processor and based on the haul volume, the haul distance, the haul cost, and the haul time, a plurality of efficiency ratings comprising an efficiency rating for at least one of the following: each driver associated with the plurality of vehicles, each transportation entity associated with the plurality of vehicles, each haul of the plurality of hauls, or any combination thereof.

2. The computer-implemented method of claim 1, wherein each efficiency rating is generated based on at least one algorithm comprising the following equation: (v*d)/(c*t), wherein v is the haul volume, d is the haul distance, c is the haul cost, and t is the haul time.

3. The computer-implemented method of claim 1, wherein at least a portion of the haul data is received directly or indirectly from a plurality of mobile devices positioned on or carried within the plurality of vehicles.

4. The computer-implemented method of claim 1, wherein generating each efficiency rating comprises:
determining, for at least one haul and based at least partially on the haul data, a raw rating for at least one of the following: at least one driver associated with the plurality of vehicles, at least one transportation entity associated with the plurality of vehicles, or any combination thereof;
sorting the raw ratings; and
assigning each raw rating an efficiency rating based at least partially on a range or scale.

5. The computer-implemented method of claim 4, wherein assigning each raw rating an efficiency rating comprises normalizing the sorted raw ratings based on a specified range.

6. The computer-implemented method of claim 4, wherein assigning each raw rating an efficiency rating comprises comparing the efficiency rating with a scale having predefined ranges.

7. The computer-implemented method of claim 1, further comprising generating at least one graphical user interface comprising a visual representation of at least one efficiency rating of the plurality of efficiency ratings.

8. The computer-implemented method of claim 1, further comprising generating at least one graphical user interface comprising at least one selectable option configured to selectively view at least two efficiency ratings of the plurality of efficiency ratings by at least one of the following: drivers, transportation entities, routes, or any combination thereof.

9. The computer-implemented method of claim 1, wherein the haul time is limited based at least partially on at least one speed limit, thereby discouraging unsafe driving practices.

10. The computer-implemented method of claim 1, wherein each efficiency rating is generated such that it is directly proportional to the haul volume and haul distance, and indirectly proportional to the haul cost and the haul time.

11. The computer-implemented method of claim 1, wherein the at least one efficiency rating is for at least one driver over a period of time comprising at least one shift.

12. A material transportation efficiency rating system, comprising:
(a) at least one data storage device comprising haul data, the haul data comprising, for each haul of a plurality of hauls, a haul volume, a haul distance, a haul cost, a haul duration, or any combination thereof, wherein each haul is associated with a truck, a driver, and/or a trucking entity; and
(b) at least one computer comprising at least one processor programmed or configured to:
(i) for each of a plurality of drivers and/or trucking entities, determining at least one efficiency rating based on the haul volume, the haul distance, the haul cost, and the haul time, resulting in a plurality of efficiency ratings;
(ii) ranking the plurality of efficiency ratings based on a scale or range, resulting in ranked efficiency ratings; and
(iii) generating at least one graphical user interface comprising at least a portion of the ranked efficiency ratings.

13. The system of claim 12, wherein each efficiency rating of the plurality of efficiency ratings is determined by at least one algorithm comprising the following equation: (v*d)/(c*t), wherein v is the haul volume, d is the haul distance, c is the haul cost, and t is the haul time.

14. The system of claim 12, wherein at least a portion of the haul data is received directly or indirectly from a plurality of mobile devices positioned in or carried within at least one vehicle.

15. The system of claim 12, wherein ranking the plurality of efficiency ratings comprises:
sorting the plurality of efficiency ratings with a sorting algorithm, resulting in a sorted order of efficiency ratings; and
assigning each efficiency rating of the plurality of efficiency ratings an efficiency rank based at least partially on the sorted order and a range or scale.

16. The system of claim 15, wherein assigning each efficiency rating an efficiency rank comprises normalizing the sorted efficiency ratings based on a specified range.

17. The system of claim 15, wherein assigning each efficiency rating an efficiency rank comprises comparing the efficiency rating with a scale having predefined ranges.

18. The system of claim 12, wherein each efficiency rating of the plurality of efficiency ratings is directly proportional to the haul volume and haul distance, and indirectly proportional to the haul cost and the haul time.

19. The system of claim 12, further comprising generating at least one user interface comprising at least one selectable option configured to selectively view the plurality of efficiency ratings by at least one of the following: drivers, transportation entities, routes, or any combination thereof.

20. A computer program product for generating material transportation efficiency ratings, comprising at least one non-transitory computer-readable medium comprising program instructions that, when executed by at least one processor, cause the at least one processor to:
obtain haul data for at least one haul made by at least one of a driver and a transportation entity, the haul data comprising a haul volume, a haul distance, a haul cost, and a haul time; and
generate, with at least one processor and based at least partially on the haul data, a plurality of efficiency ratings comprising an efficiency rating for at least one of the following: each driver associated with the plurality of vehicles, each transportation entity associated with the plurality of vehicles, each haul of the plurality of hauls, or any combination thereof, wherein each efficiency rating is generated such that it is directly proportional to the haul volume and haul distance, and indirectly proportional to the haul cost and the haul time.

21. The computer program product of claim 20, wherein each efficiency rating is generated based on at least one algorithm comprising the following equation: (v*d)/(c*t), wherein v is the haul volume, d is the haul distance, c is the haul cost, and t is the haul time.

22. The computer program product of claim 20, wherein generating each efficiency rating comprises:
determining, for at least one haul and based at least partially on the haul data, a raw rating for at least one of the following: at least one driver associated with the plurality of vehicles, at least one transportation entity associated with the plurality of vehicles, or any combination thereof;
sorting the raw ratings; and
assigning each raw rating an efficiency rating based at least partially on a range or scale.

23. The computer program product of claim 20, wherein the at least one efficiency rating is at least partially generated by weighing at least one of the haul volume and the haul distance against at least one of the haul cost and the haul time.

24. The computer program product of claim 20, wherein at least a portion of the haul data is obtained from mobile devices positioned on or carried within the at least one vehicle.
